(19) United States
(12) Patent Application Publication
(10) Pub. No.: US 2008/0066589 A1
(43) Pub. Date: Mar. 20, 2008

(54) Screwdriver with slip-resistant blade

(76) Inventor: Shiang Tseng, Taoyuan City (TW)

Correspondence Address: Tseng, Shiang, apt 3D, 3620 168th St., Flushing, NY, 11358, US

(21) Appl. No.: 11/293,696

(22) Filed: Dec. 5, 2005

(51) Int. Cl. B25B 15/00; B25B 13/48

(52) U.S. Cl. 81/436

(57) ABSTRACT

A screwdriver with slip-resistant blade includes a handle being provided on an outer surface with a plurality of parallel and axially extended ribs, and a blade having a proximal end connected to the handle and a distal end formed into an operating tip. Theblade is formed on an outer surface at a predetermined position with a coarse and highly frictional area as a slip-resistant section. When the screwdriver is used to loosena screw, the user may grip at the slip-resistant section of the blade to efficiently turn the screw with shortened time and less effort after the screw has been primarily turned and loosened by turning the handle of the screwdriver.

### FIELD OF THE INVENTION

The present invention relates to a screwdriver, and more particularly to a screwdriver with slip-resistant blade that allows a user to efficiently loosen a screw with shortened time and less effort.

### BACKGROUND OF THE INVENTION

FIG. 12 shows a conventional screwdriver 30, which includes a handle 31 and a blade 32. The handle 31 has a diameter larger than that of the blade 32, and is provided on a circumferential surface with alternate flutes and ribs to form a slip-resistant section 311. The blade 32 has a proximal end connected to the handle 31 and a distal end formed into a keystone tip or a Philip tip.

When the screwdriver 30 is used to loosen a screw from a screw hole, a user typically holds the screwdriver 30 at the handle 31 and presses the tip of the blade 32 against the screw. When the user applies a force to turn the handle 31, the blade 32 is brought to turn at the same time and thereby loosens the screw from the screw hole by a small degree. Thereafter, the screw may be further loosened with less effort.

Since the blade 32 is diametrically smaller than the handle 31, the blade 32 has a circumferential length smaller than that of the handle 31, too. This means the time needed to turn the handle 31 a certain angle is shorter than the time needed to turn the blade 32 the same angle. Therefore, when the screw has been primarily loosened by turning the screwdriver at the handle 31, the user may move the hand holding the screwdriver 30 from the handle 31 to the blade 32, and conveniently grips the blade 32 with the thumb and index finger of the hand, and turns the blade 32 one circle with time shorter than that for turning the handle 31 one circle. Thus, the screw can be loosened more quickly. However, the blade 32 of the conventional screwdriver 30 has a smooth outer surface that is not easily to firmly and stably grip. The blade 32 tends to slip off the user's hand, particularly when the user's hand sweats after having gripped the blade 32 for a prolonged time.

### SUMMARY OF THE INVENTION

A primary object of the present invention is to provide a screwdriver with slip-resistant blade that allows a user to loosen a screw with shortened time and less effort by gripping at and turning the slip-resistant blade.

To achieve the above and other objects, the screwdriver according to the present invention includes a handle being provided on an outer surface with a plurality of parallel and axially extended ribs, and a blade having a proximal end connected to the handle and a distal end formed into an operating tip. The blade is formed on an outer surface at a predetermined position with a coarse and highly frictional area as a slip-resistant section. When the screwdriver is used to further loosen a screw, the user maygrip at the slip-resistant section of the blade to efficiently turn the screw with shortened time and less effort.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a screwdriver with slip-resistant blade according to a first preferred embodiment of the present invention;

FIG. 2 is a perspective view of a screwdriver with slip-resistant blade according to a second preferred embodiment of the present invention;

FIG. 3 is a perspective view of a screwdriver with slip-resistant blade according to a third preferred embodiment of the present invention;

FIG. 4 is a perspective view of a screwdriver with slip-resistant blade according to a fourth preferred embodiment of the present invention;

FIG. 5 is a perspective view of a screwdriver with slip-resistant blade according to a fifth preferred embodiment of the present invention;

FIG. 6 is a perspective view of a screwdriver with slip-resistant blade according to a sixth preferred embodiment of the present invention;

FIG. 7 is an enlarged view of the circled area of FIG. 6;

FIG. 8 is a perspective view of a screwdriver with slip-resistant blade according to a seventh preferred embodiment of the present invention;

FIG. 9 is a perspective view of a screwdriver with slip-resistant blade according to an eighth preferred embodiment of the present invention;

FIG. 10 is a perspective view of a screwdriver with slip-resistant blade according to a ninth preferred embodiment of the present invention;

FIG. 11 is a perspective view of a screwdriver with slip-resistant blade according to a tenth preferred embodiment of the present invention; and

FIG. 12 is a perspective view of a conventional screwdriver.

### DETAILED DESCRIPTION OF THE PREFERRED EMBODIMENTS

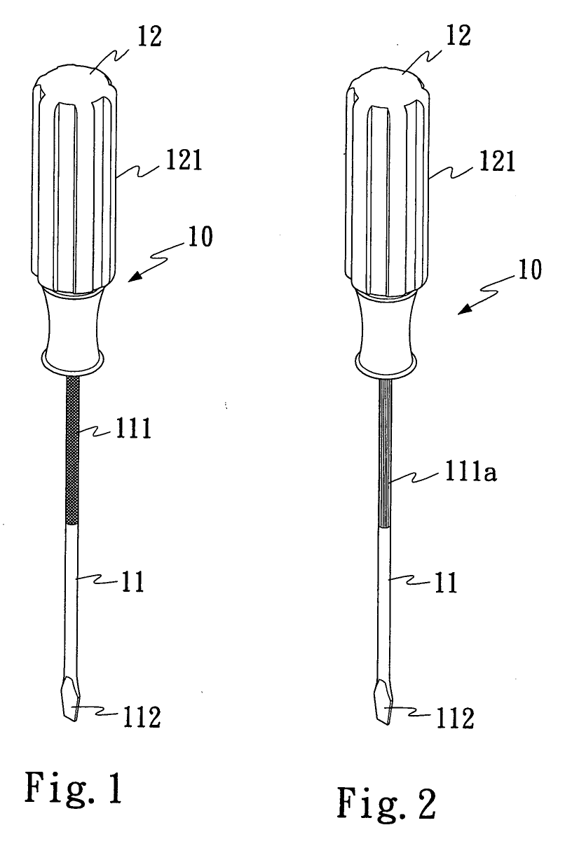

Please refer to FIG. 1 that is a perspective view of a screwdriver with slip-resistant blade 10 according to a first preferred embodiment of the present invention. As shown, the screwdriver 10 includes a blade 11 and a handle 12.

The handle 12 is provided on an outer surface with a plurality of axially extended and spaced ribs 121.

The blade 11 has a diameter small than that of the handle 12, and is connected at a proximal end to the handle 12. A distal end of the blade 11 is an operating tip 112, which may be a keystone tip or a Philip tip. The blade 11 is provided at a predetermined position.with a slip-resistant section 111 having a coarse and highly frictional outer surface. The slip-resistant section 111 may be located near the handle 12, and the coarse surface of the slip-resistant section 111 may be produced by engraving, etching, or knurling. In the illustrated first preferred embodiment of the present invention, the slip-resistant section 111 of the blade 11 contains a plurality of crossed lines to provide the coarse and highly frictional surface thereof.

To use the screwdriver 10 of the present invention to loosen a screw from a screw hole, a user first holds and turns the screwdriver 10 at the handle 12. With the ribs 121 provided on the outer surface of the handle 12, the handle 12 can be more securely held and turned without the risk of sliding off the user's hand. In this manner, the user may easily apply a rotational force on the handle 12 to loosen the screw. Once the screw is primarily turned, it is no longer so tightly locked in the screw hole, and the user needs only to apply a minor force at this stage to completely loosen the screw from the screw hole.

Since the blade 11 is diametrically smaller than the handle 12, it is obvious the time needed to turn the blade 11 one circle is shorter than that to turn the handle 12 one circle, and the screwdriver 10 may be more quickly turned by directly turning the blade 11. Therefore, the user may move his hand from the handle 12 to the slip-resistant section 111 of the blade 11, and directly turn the blade 11 to reduce the time needed to completely loosen and remove the screw that has been primarily loosened by turning the handle 12. With the slip-resistant section 111, the blade 11 having small diameter may still be conveniently and securely held using the thumb and index finger of one hand without the risk of sliding off the user's hand.

FIG. 2 is a perspective view of a screwdriver with slip-resistant blade 10 according to a second preferred embodiment of the present invention. As shown, the screwdriver 10 in the second embodiment is structurally similar to the first embodiment, except for a slip-resistant section llla that contains a plurality of parallel and axially extended straight lines to provide. the coarse and highly frictional surface thereof.

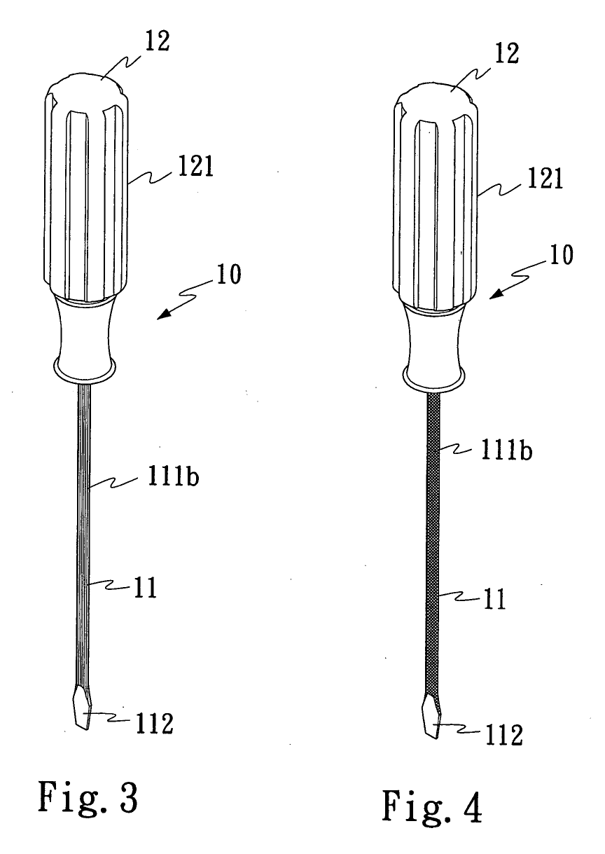

FIG. 3 is a perspective view of a screwdriver with slip-resistant blade 10 according to a third preferred embodiment of the present invention. As shown, the screwdriver 10 in the third embodiment is structurally similar to the second embodiment, except for an slip-resistant section lllb that is provided on a whole outer surface of the blade 11, and contains a plurality of parallel straight lines axially extended along a full length of the blade 11 to provide the coarse and highly frictional surface of the slip-resistant section 111b.

FIG. 4 is a perspective view of a screwdriver with slip-resistant blade 10 according to a fourth preferred embodiment of the present invention. As shown, the screwdriver 10 in the fourth embodiment is structurally similar to the third embodiment, except for a slip-resistant section lllb containing a plurality of crossed straight lines to provide the coarse and highly frictional surface thereof.

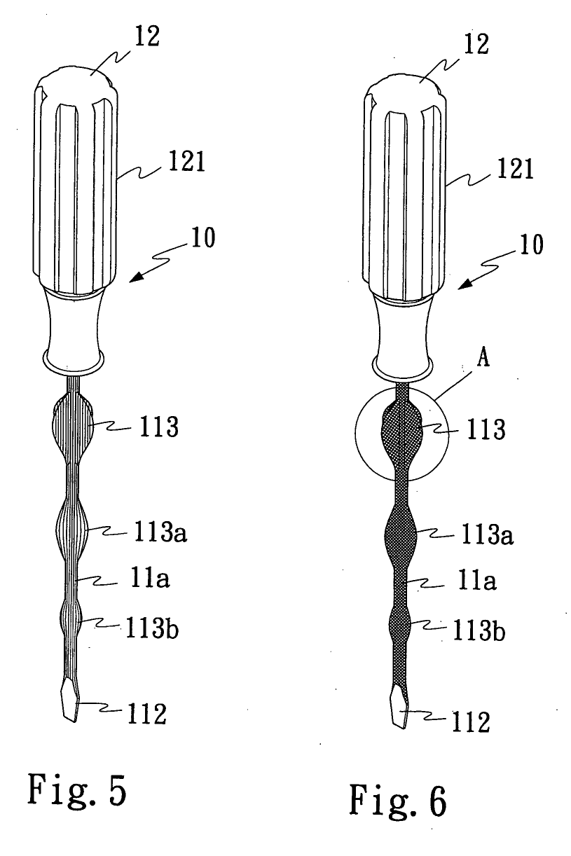

FIG. 5 is a perspective view of a screwdriver with slip-resistant blade 10 according to a fifth preferred embodiment of the present invention. As shown, the screwdriver 10 in the fifth embodiment is different fromthepreviousembodimentsinabladella. The blade lla is provided on the outer surface between the proximal end and the distal operating tip 112 with a plurality of radially. protruded curved sections. In the illustrated embodiment, there are three, radially protruded curved sections 113, 113a, 113b continuously arranged from the proximal end toward the operating tip 112. The innermost curved section 113, that is, the curved section closest to the handle 12, may have a round, a polygonal, or a petal-like cross section, while the other two curved sections 113a, 113b have simple round cross section with different sizes. The differently sized protruded curved sections 113, 113a, and 113b are selectively turned corresponding to the tightness of the screw to be loosened, in order to increase the operating efficiency of the screwdriver 10. For example, the user may hold the screwdriver 10 at the protruded curved section 113a, which has a relatively large circumference, to turn a partially loosened screw with only a minor force; or at the protruded curved section 113b, which has a relatively small circumference, to turn the screw with a moderate force. In the fifth embodiment, the blade la contains a plurality of parallel lines on the outer surface thereof to axially extend along a full length of the blade lla.

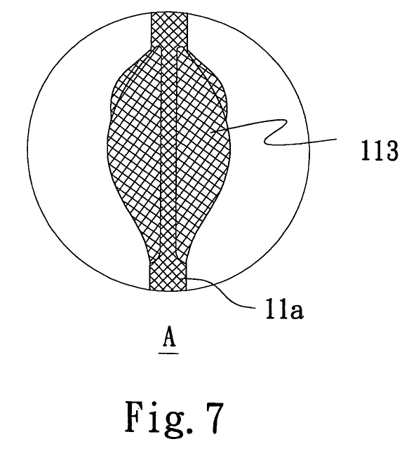

FIG. 6 is a perspective view of a screwdriver with slip-resistant blade 10 according to a sixth preferred embodiment of the present invention. As shown, the screwdriver 10 in the sixth embodiment is structurally similar to the fifth embodiment, except that the blade lla in the sixth embodiment contains a plurality of crossed lines provided on the whole outer surface thereof. FIG. 7 is an enlarged view of the circled area A of FIG. 6.

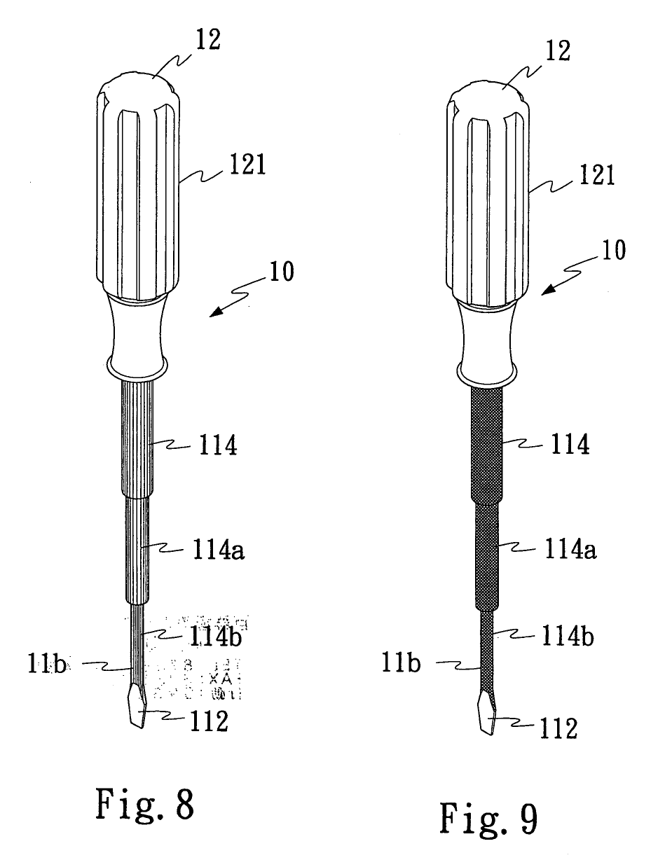

Please refer to FIG. 8 that is a perspective view of a screwdriver with slip-resistant blade 10 according to a seventh preferred embodiment of the present invention. As shown, the screwdriver 10 in the seventh embodiment is different from the previous embodiments in a blade 11b. The blade 11b has a stepped outer surface and is thereby divided into at least three axially continuous sections 114, 114a, 114b with different diameters. The three sections of different diameters 114, 114a, and 114b are selectively turned corresponding to the tightness of the screw to be loosened, in order to increase the operating efficiency of the screwdriver 10. For example, the user may hold the screwdriver 10 at the first section 114, which is closest to the handle 12 and has a relatively large diameter and accordingly circumference, to turn a not yet completely loosened screw with only a minor force; or at the second section 114a, which is located immediately before the first section 114 and has a somewhat smaller diameter and circumference than that of the first section 114, to turn the screw with a moderate force. In the seventh embodiment, the blade 11b contains a plurality of parallel lines on the outer surface thereof to axially extend along a full length of the blade 11b.

FIG. 9 is a perspective view of a screwdriver with slip-resistant blade 10 according to an eighth preferred embodiment of the present invention. As shown, the screwdriver 10 in the eighth embodiment is structurally similar to the seventh embodiment, except that the blade 11b in the eighth embodiment contains a plurality of crossed lines provided on the whole outer surface thereof.

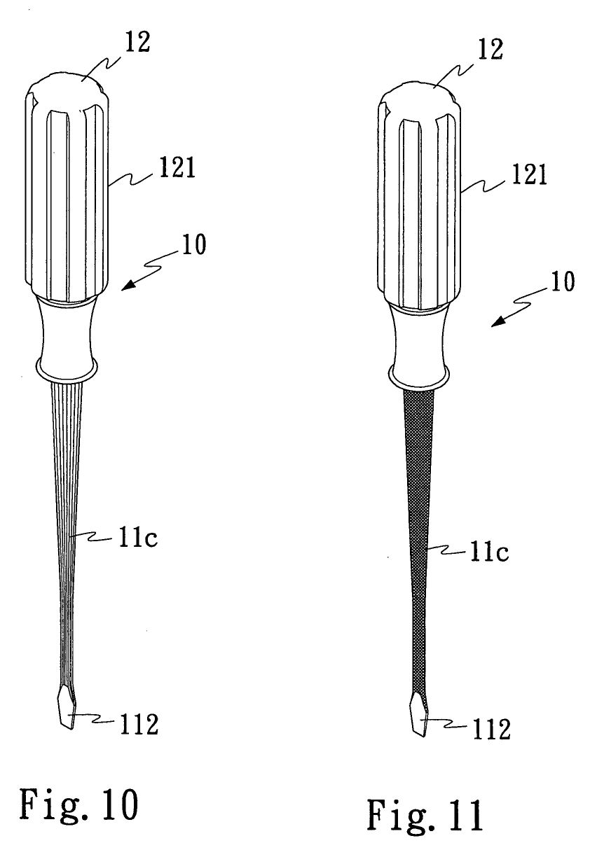

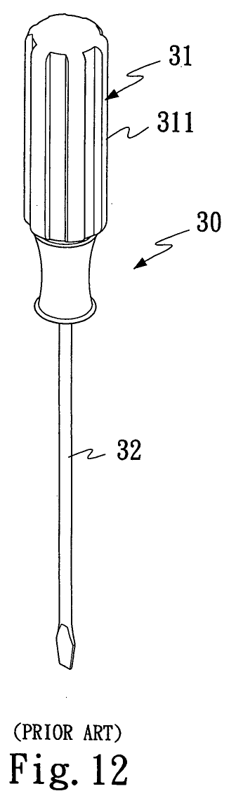

Please refer to FIG. 10 that is a perspective view of a screwdriver with slip-resistant blade 10 according to a ninth preferred embodiment of the present invention. As shown, the screwdriver 10 in the ninth embodiment is different from the previous embodiments in a blade 11c. The blade 11c has an outer surface tapered from the proximal end toward the operating tip 112 and containing a plurality of parallel lines axially extended a full length of the blade 11c. The user may hold the screwdriver 10 at the tapered blade 11c and move the fingers gripping the blade 11c to different positions according to the tightness of the screw to be loosened.

FIG. 11 is a perspective view of a screwdriver with slip-resistant blade 10 according to a tenth preferred embodiment of the present invention. As shown, the screwdriver 10 in the tenth embodiment is structurally similar to the ninth embodiment, except that the tapered blade lic in the tenth embodiment contains a plurality of crossed lines provided on the whole outer surface thereof.

In brief, the screwdriver with slip-resistant blade according to the present invention includes a blade having an outer surface partially or completely provided with a coarse and highly frictional area as a slip-resistant section, so that a user may hold the screwdriver at the slip-resistant section of the blade to quickly turn the screwdriver and loosen a screw with less effort and shortened time.

The present invention has been described with some preferred embodiments thereof and it is understood that many changes and modifications in the described embodiments can be carried out without departing from the scope and the spirit of the invention that is in tended to be limited only by the appended claims.

1. A screwdriver with slip-resistant blade, comprising:
a handle having a plurality of axially and parallelly extended ribs provided on an outer surface; and
a blade having a proximal end connected to said handle, and a distal end formed into an operating tip; and said blade being provided on an outer surface at a predetermined position adjacent the handle with a coarse and highly frictional area to serve as a slip-resistant section.

2. The screwdriver with slip-resistant blade as claimed in claim 1, wherein said slip-resistant section is produced in a manner selected from the group consisting of engraving, etching, and knurling.

3. (canceled)

4. The screwdriver with slip-resistant blade as claimed in claim 1, wherein said coarse area forming said slip-resistant section contains a pattern selected from the group consisting of parallelly extended straight lines and other designs.

5. The screwdriver with slip-resistant blade as claimed in claim 1, wherein said slip-resistant section is provided on the whole outer surface of said blade.

6. The screwdriver with slip-resistant blade as claimed in claim 1, wherein said blade is axially continuously provided on the outer surface with a plurality of radially protruded curved sections.

7. The screwdriver with slip-resistant blade as claimed in claim 1, wherein said blade has a stepped outer surface to divide said blade into at least three axially continuous sections with different diameters.

8. The screwdriver with slip-resistant blade as claimed in claim 1, wherein said blade has an outer surface tapered from said proximal end toward said operating tip.

9. A screwdriver with slip-resistant blade as claimed in claim 1, wherein at least a third of a length of the blade is covered by the frictional area.

10. A screwdriver with slip-resistant blade as claimed in claim 1, wherein a majority of a length of the blade is covered by the frictional area.

11. A screwdriver with slip-resistant blade as claimed in claim 1, wherein the operating tip is free of the frictional area.

12. A screwdriver with slip-resistant blade, comprising:
a handle having a plurality of axially and parallelly extended ribs provided on an outer surface;
a blade having a proximal end connected to said handle, and a distal end formed into an operating tip; and
means for providing a slip-resistant grip for a user's hand, the means includes a coarse and highly frictional area on the blade, the frictional area covering a predetermined position of the blade.

13. A screwdriver with slip-resistant blade as claimed in claim 12, wherein the predetermined position with the frictional area is adjacent the handle.

14. A screwdriver with slip-resistant blade as claimed in claim 12, wherein the operating tip is free of the frictional area.

15. A screwdriver with slip-resistant blade as claimed in claim 12, wherein a majority of a length of the blade is covered by the frictional area.

16. A screwdriver with slip-resistant blade as claimed in claim 12, wherein said slip- resistant section is produced in a manner selected from the group consisting of engraving, etching, and knurling and wherein said coarse area forming said slip-resistant section contains a pattern selected from the group consisting of parallelly extended straight lines and other designs.

17. The screwdriver with slip-resistant blade as claimed in claim 12, wherein said slip-resistant section is provided on the whole outer surface of said blade.

18. The screwdriver with slip-resistant blade as claimed in claim 12, wherein said blade is axially continuously provided on the outer surface with a plurality of radially protruded curved sections.

19. The screwdriver with slip-resistant blade as claimed in claim 12, wherein said blade has a stepped outer surface to divide said blade into at least three axially continuous sections with different diameters.

20. The screwdriver with slip-resistant blade as claimed in claim 12, wherein said blade has an outer surface tapered from said proximal end toward said operating tip.
